(19) United States
(12) Patent Application Publication
(10) Pub. No.: US 2010/0251351 A1
(43) Pub. Date: Sep. 30, 2010

(54) INFORMATION AND COMMUNICATION SYSTEM, AN ORGANIZATION APPARATUS AND A USER APPARATUS

(76) Inventor: Isamu Teranishi, Tokyo (JP)

Correspondence Address: Mr. Jackson Chen, 6535 N. STATE HWY 161, IRVING, TX, 75039, US

(21) Appl. No.: 12/743,553

(22) PCT Filed: Oct. 31, 2008
(86) PCT No.: PCT/JP2008/069972

§ 371 Date: May 18, 2010

(30) Foreign Application Priority Data
Nov. 21, 2007 (JP) 2007-301466

(51) Int. Cl. H04L 9/32; G06F 21/00

(52) U.S. Cl. 726/7; 726/10

(57) ABSTRACT

An information and communication system or the like which handles an attribute, at the same time enables the attribute not being made a public information, is efficient, and does not require a database should be provided.

Pseudonym and validation tag generation means output validation tag including a commitment of a secret key of a user apparatus and a pseudonym, credential generation means outputs a signed document corresponding to a validation tag and a pseudonym as a credential, a user apparatus transmits a signed document to a verifier apparatus, a user apparatus proves to a verifier apparatus that a validation tag is a commitment of a secret key, a verifier apparatus verifies a signed document, and a verifier apparatus verifies the proof that a validation tag is a commitment of a secret key.

### TECHNICAL FIELD

The present invention relates to an efficient anonymous credential technology.

### BACKGROUND ART

### Anonymous Credential

An anonymous credential system is a technology certified by a pseudonym.

An anonymous credential system has various versions, and a system disclosed in non-patent literature 1 is described here according to FIG. 1.

For an anonymous credential system of non-patent literature 1, four kinds of entities, an organization, a user, a verifier and a database administrator are necessary. An organization manages a user's group.

It is supposed that a user, an organization, a verifier and a database administrator possess a computer (personal computer, for example).

Computers which an organization, a user, a verifier and a database administrator possess are represented as an organization apparatus 1, a user apparatus 2, a verifier apparatus 3 and a database administrator apparatus 4 respectively.

An organization apparatus 1 includes an operation unit 17, a memory unit 18 and a communication unit 19. Similarly, a user apparatus 2 includes an operation unit 27, a memory unit 28 and a communication unit 29. Similarly, a verifier apparatus 3 includes an operation unit 37, a memory unit 38 and a communication unit 39.

A database administrator apparatus includes a communication unit 49 and a database 410. As an operation unit, a memory unit and a communication unit of these apparatuses, for example, CPU, a hard disk drive and a port for an internet can be used respectively, though, any kind of apparatus may be used. The apparatuses can communicate via any networks between them. As a network, there exists an internet, for example. And, as a network, any kind of network may be used.

It is also supposed that each organization apparatus 1 has some methods to publish its own public key. For example, an organization apparatus 1 can publish a public key by utilizing a mechanism of PKI.

In an anonymous credential, data such as a pseudonym, a validation tag and a credential are dealt with. A pseudonym is assigned to a user when a user joins a group.

A credential is a certificate that proves a user with a pseudonym certainly belongs to the group.

An anonymous credential system has the following procedures.

1. Organization key generation 11

2. User secret key generation 21

3. Pseudonym generation (12 and 22)

4. Credential generation (13 and 23)

5. Credential possession proof 24 and credential possession verification 34

6. Validation tag relationship proof 26 and validation tag relationship verification 36

In non-patent literature 1, above mentioned 1, 3, 4, 5 and 6 are represented as “System Parameter and Key Generation”, “Generation of Pseudonym”, “Generation of a Credential”, “Showing a Single Credential” and “Showing Credential with Respect to a Pseudonym” respectively.

Organization key generation 11 is an algorithm which generates a public key and a secret key of an organization apparatus, and is executed when each organization establishes a group.

Pseudonym generation (12 and 22) is a protocol executed when a user belongs to one of groups newly, and is executed between the organization which manage the group and the user. When the protocol ends normally, the user's pseudonym and the validation tag in this group are generated.

From a view point of security, communication during pseudonym generation is preferred not to be wiretapped. For example, wiretapping can be prevented by encrypting the communication contents.

Credential generation (13 and 23) is a protocol which generates a credential, a certificate which proves the validity of the user's validation tag, and is executed between the user and the organization.

Credential possession proof 24 is a procedure which proves to a verifier that the user belongs to the group. Credential possession verification 34 is a procedure by which a verifier verifies the proof.

Validation tag relationship proof 26 is a procedure which, when a user belongs to two groups, proves to a verifier that validation tags used in each group are possessed by the same person. Validation tag relationship verification 36 is a procedure by which a verifier verifies the proof.

A database administrator publishes a user's database. Whenever a user performs pseudonym generation (12 and 22), a database administrator adds a pair of user's pseudonym and validation tag to the database. Also whenever a user performs credential generation (13 and 23), a database administrator adds an information of a credential.

(Preparations)

[Universal Designated-Verifier Signature Scheme]

A universal designated-verifier signature scheme is a method proposed in non-patent literature 2.

A universal designated-verifier signature scheme includes seven algorithms: public information generation, signer key generation, verifier key generation, original signature generation, verification, designated-verifier signature generation and designated-verifier verification.

Public information generation receives security parameter λ as an input, and outputs public information param.

Signature key generation receives public information param as an input, and outputs a signer's public key spk and a signer's secret key ssk.

Verifier key generation receives public information param as an input, and outputs a verifier's public key vpk and a verifier's secret key vsk.

Original signature generation receives public information param, a signer's secret key ssk and a message M as an input, and outputs an original signed document S.

Verification receives public information param, a signer's public key spk, a message M and an original signed document S as an input, and outputs “accept” or “reject”.

Designated-verifier signature generation receives public information param, a signer's public key spk, a verifier's public key vpk, a message M and a signed document S as an input, and outputs a designated-verifier signed document σ.

Designated-verifier verification receives public information param, a signer's public key spk, a verifier's public key vpk, a message M and a designated-verifier signed document σ as an input and outputs “accept” or “reject”.

In non-patent literature 2, the following universal designated-verifier signature scheme is proposed.

It is supposed that groups G_{—}1, G_{—}2 and G_T have an order of λ bit, and have a pairing <*,*>: G_{—}1×G_{—}2->G_T and a mapping ψ: G_{—}2->G_{—}1.

q is an order of G_{—}1 (=order of G_{—}2=order of G_T). H is a hash function which has a range over G_{—}2.

Public information generation chooses an element g_{—}1 in G_{—}1 at random, defines g_{—}2=ψ(g_{—}1), and outputs param=(g_{—}1, g_{—}2).

Signature key generation receives param=(g_{—}1, g_{—}2) as an input, chooses an element ssk in Z_q at random, calculates spk=g_{—}1̂[ssk] and outputs spk and ssk as a public key and a secret key respectively.

Verifier key generation receives param=(g_{—}1, g_{—}2) as an input, chooses an element vsk in Z_q at random, calculates vpk=g_{—}1̂[vsk] and outputs vpk and vsk as a public key and a secret key respectively.

Original signature generation receives a signer's secret key ssk and a message M as an input, calculates S=H (M)̂[ssk] and outputs S as an original signed document.

Verification receives a signer's public key spk, a message M and an original signed document σ as an input and, if <g_{—}1, S>=<spk, H(M)> then outputs “accept”, otherwise outputs “reject”.

Designated-verifier signature generation receives a signer's public key spk, a verifier's public key vpk, a message and a signed document S as an input, and outputs σ=<vpk, S>.

Designated-verifier verification receives a signer's public key spk, a verifier's public key vpk, a message and a designated-verifier signed document σ as an input and, if σ=<spk̂[vsk], H(M)> then outputs “accept”, otherwise outputs “reject”.

Here, a technology by which respective users can communicate securely is proposed, wherein a certificate issuing apparatus is configured so that attribute information is published equally among a plurality of users (for example, refer to patent literature 1). The configuration is a configuration that a certificate issuing apparatus includes a public key storage means stores an object user's public key, a secret key storage means stores a secret key corresponding to the above-mentioned public key, an attribute information publishing means publishes an attribute identifier corresponding to the object user's attribute information, a user value generation means generates an object user's specific value, and a certificate issuing means issues to an object user a certificate including secret information based on the above-mentioned secret key, the above-mentioned object user's specific value and the above-mentioned attribute identifier.
Patent document 1: Japanese Patent Application Laid-Open No. 2001-209313
Non-patent literature 1: Jan Camenisch and Anna Lysyanskaya: An Efficient System for Non-transferable Anonymous Credentials with Optional Anonymity Revocation. EUROCRYPT 2001. pp. 93-118.
Non-patent literature 2: Ron Steinfeld, Laurence Bull, Huaxiong Wang and Josef Pieprzyk: Universal Designated-Verifier Signatures. ASIACRYPT 2003. pp. 523-542.

### DISCLOSURE OF THE INVENTION

### Problems to be solved by the invention

However, the above-mentioned related technology has a problem that it handles user's attributes such as age, distinction of sex and tastes as public information.

The method of non-patent literature 1 can handle attributes if an attribute is written in a free description unit of a pseudonym. However, as information in the free description unit is public information, the method of non-patent literature 1 cannot keep secrecy of an attribute. It is also a problem to improve the poor efficiency of the method of non-patent literature 1.

Further, the method of non-patent literature 1 has to configure a database independently in addition to an organization, a user and a verifier.

The present invention has been made in order to solve the problems mentioned above, and has as an object to provide an information and communication system, an organization apparatus and a user apparatus which handle an attribute, at the same time enable attributes not being made public information, are efficient and do not require a database.

### Means for Solving the Problems

In order to achieve an object, the present invention has the following features.

The first information and communication system of the present invention is an information and communication system including:

an organization apparatus, a user apparatus and a verifier apparatus, wherein

a user apparatus includes its own secret key;

and further including; means for generating a pseudonym and a validation tag;

means for generating a credential which proves that a pseudonym and a validation tag are issued by the organization apparatus;

means for proving possession of a credential; and

means for verifying possession of a credential;

wherein

the means to generate a pseudonym and a validation tag outputs a validation tag including a commitment of a secret key of the user apparatus and a pseudonym;

the means to generate a credential outputs a signed document corresponding to the validation tag and to the pseudonym as a credential;

in the means to prove possession of a credential, a user apparatus transmits the signed document to the verifier apparatus;

the user apparatus proves to the verifier apparatus that the validation tag is a commitment of the secret key;

in the means to verify possession of a credential, the verifier apparatus verifies the signed document; and

the verifier apparatus further verifies a proof that the validation tag is a commitment of the secret key.

And the second information and communication system of the present invention is an information and communication system including:

an organization apparatus, a user apparatus and a verifier apparatus, wherein

a user apparatus includes its own secret key;

further including; means for generating a pseudonym and a validation tag;

means for generating a credential which proves that a pseudonym is issued by the organization apparatus;

means for proving possession of a credential; and

means for verifying possession of a credential;

wherein

the means to generate a pseudonym and a validation tag makes certain bit string into a pseudonym;

the user apparatus further makes those including a commitment of its own secret key a validation tag;

the means to generate a credential creates an original signed document corresponding to the validation tag according to an original signature generation means of a universal designated-verifier signature scheme;

further outputs the original signed document as a credential;

the means to prove possession of a credential proves a knowledge of the original signed document without showing the original signed document; and

the means to verify possession of a credential verifies a knowledge of the original signed document without showing the original signed document.

### ADVANTAGEOUS EFFECT OF THE INVENTION

According to the present invention, an information and communication system, an organization apparatus and a user apparatus, which handle an attribute, at the same time enable attributes not being made a public information, are efficient and do not require a database, can be provided.

### BEST MODE FOR CARRYING OUT THE INVENTION

### Apparatus Configuration and Procedure

The apparatus configuration of the present invention is similar to that of non-patent literature 1. However, a database administrator does not exist in the apparatus configuration of the present invention.

Three kinds of entities, a user, an organization and a verifier participate in the present invention.

It is supposed that a user, an organization and a verifier possess a computer (personal computer, for example).

The present invention is applied, for example, to an information and communication system as shown in FIG. 2. This information and communication system includes, as is shown in FIG. 2 mentioned above, a user apparatus 2, an organization apparatus 1 and a verifier apparatus 3.

Computers which a user and an organization possess are called a user apparatus 2, an organization apparatus 1 and a verifier apparatus 3 respectively. These apparatuses include an operation unit, a memory unit and a communication unit. As an operation unit, a memory unit and a communication unit, for example, CPU, a hard disk and a port for an internet can be used respectively. And, any kind of such device may be used.

The apparatuses can communicate via any networks between them. As a network, there exists an internet, for example. And as a network, any kind of network may be used.

It is also supposed that each organization apparatus 1 has some methods, to publish its own public key. For example, an organization apparatus 1 can publish a public key by utilizing a mechanism of PKI.

The procedure of the present invention is similar to that of non-patent literature 1. However, procedures such as attribute proof 25 and attribute verification 35 are added newly in the procedure of the present invention.

The present invention has the following procedures.

1. Organization key generation 11

2. User secret key generation 21

3. Pseudonym generation (12 and 22)

4. Credential generation (13 and 23)

5. Credential possession proof 24 and credential possession verification 34

6. Attribute proof 25 and attribute verification 35

7. Validation tag relationship proof 26 and validation tag relationship verification 36

The role of the procedures other than attribute proof 25 and attribute verification 35 is the same as that of non-patent literature 1.

### The First Exemplary Embodiment

It is supposed that Σ=(Gen, Sig, Ver) is a signature scheme. Here, it is supposed that Gen is a key generation algorithm of Σ, Sig is a signature algorithm and Ver is a verification algorithm. Further, it is supposed that G is a cyclic group having a prime order and a discrete logarithm problem on G is hard. It is supposed that q is an order of G. Further, it is supposed that H is a hash function, and λ is a security parameter.

<Organization Key Generation 11>

O which is an organization apparatus 1 performs organization key generation 11 as follows.

1. O reads λ from a memory unit.

2. O executes Gen(λ) and, as an output of Gen, gets a public key spk for signature and a secret key ssk for signature.

3. O chooses a natural number m and chooses elements K_[O0], L_[O0], . . . , K_[Om] and L_[Om] in G at random.

4. (spk, K_[O0], L_[O0], . . . , K_[Om], L_[Om]) is considered as a public key and ssk is considered as a secret key.

5. O writes a public key (spk, K_[O0], L_[O0], . . . , K_[Om], L_[Om]) and a secret key ssk in a memory unit.

6. O publishes a public key (spk, K_[O0], L_[O0], . . . , K_[Om], L_[Om]).

<User Secret Key Generation 21>

U which is a user apparatus 2 performs user secret key generation 21 as follows.

1. U chooses an element x_U in G at random.

2. U writes x_U in a memory unit.

<Pseudonym Generation (12 and 22)>

It is supposed that W_[N1], . . . , W_[Nm] are user's attributes.

U which is a user apparatus 2 and an organization O perform pseudonym generation (12 and 22) as follows.

1. O chooses a message N_{—}2 and sends it to U via a network.

2. U chooses a message N_{—}1 and defines pseudonym N by N=N_{—}1∥N_{—}2.

3. U chooses elements R_[N0], . . . , R_[Nm] in G at random.

4. U calculates Q_[N0]=K_[O0]̂[x_U]L_[O0]̂[R_[N0]] and proves the validity of Q_[N0]. And O verifies the proof.

5. U calculates Q_[N1]=K_[O1]̂[H(W_{—}1)]L_[O1]̂[R_[N1]], . . . , Q_[Nm]=K_[Om]̂[H(W_m)]L_[Om]̂[R_[Nm]].

6. U sends (Q_[N0], Q_[N1], . . . , Q_[Nm]) to O via a network and proves the validity of Q_[N0], Q_[N1], . . . , Q_[Nm]. And O verifies the proof.

7. U stores a pseudonym N and a validation tag (Q_[N0], Q_[N1], . . . , Q_[Nm]), W_[N1], . . . , W_[Nm], R_[N0], . . . , R_[Nm]) in a memory unit.

U may prove the knowledge of x_U and R_[N0] using any kind of method. U, for example, can prove it using the following method.

1. O chooses elements c and r in Z_q at random, calculates C=K_[O0]̂[c]L[O0]̂r and transmits C to U.

2. U chooses elements x′ and R′ in Z_q at random, calculates Q′=K_[O0]̂[x′]L_[O0]̂[R′] and transmits Q′ to O.

3. O transmits c and r to U.

4. U confirms whether C=K_[O0]̂[c]L_[O0]̂r is true. If C=K_[O0]̂[c]L_[O0]̂r is not true, U finishes the proof.

5. U calculates ρ_x=cx_U+x′ mod q and ρ_R=cR_[N0]+R′ mod q, and transmits ρ_x and ρ_R to O.

6. O confirms whether Q_[N0]̂cQ′=K_[O0]̂[ρ_x]L_[O0]̂[ρ_R] is true, and if it is true, accepts the proof, otherwise, rejects the proof.

U may prove the knowledge of R_[Ni] using any kind of method. U, for example, can prove it using the following method.

1. O chooses elements c and r in Z_q at random, calculates C=K_[Oi]̂[c]L_[Oi]̂r and transmits C to U.

2. U chooses an element R′ in Z_q at random, calculates Q′=L_[Oi]̂[R′] and transmits Q′ to O.

3. O transmits c and r to U.

4. U confirms whether C=K_[Oi]̂[c]L_[Oi]̂r is true. If C=K_[Oi]̂[c]L_[Oi]̂r is not true, U finishes the proof.

5. U calculates ρ_R=cR_[Ni]+R′ mod q and transmits ρ_R to O.

6. O confirms whether (Q_[Ni]/K_[Oi]̂[H(W_i)])̂cQ′=L_[Oi]̂[ρ_R] is true, and if it is true, accepts the proof, otherwise, rejects the proof.

<Credential Generation (13 and 23)>

U which is a user apparatus 2 and an organization O perform credential generation (13 and 23) using the following method.

1. U reads (N, Q_[N0], Q_[N1], . . . , Q_[Nm]) from a memory unit and sends (N, Q_[N0], Q_[N1], . . . , Q_[Nm]) to O via a network.

2. O reads ssk from a memory unit, calculates a signature S_N=Sig_[ssk](N, Q_[N0], Q_[N1], . . . , Q_[Nm]) corresponding to (N, Q_[N0], Q_[N1], . . . , Q_[Nm]) and transmits S_N to U.

3. U executes Ver_[spk] ((N, Q_[N0], Q_[N1], . . . , Q_[Nm]), S_N), and if Ver_[spk] outputs accept, writes S_N as a credential in a memory unit. Otherwise, credential generation (13 and 23) fails.

<Credential Possession Proof 24 and Credential Possession Verification 34>

It is supposed that N is a pseudonym of U which is a user apparatus 2 in a group which an organization O manages.

U operates as follows when possession of a credential corresponding to N is proved to V which is a verifier apparatus 3.

1. U reads a public key of an organization O, K_[O0], L_[O0] and (N, Q_[N0], x_U, R_[N0], S_N) from a memory unit.

2. V reads a public key spk of an organization O, K_[O0], L_[O0] and (N, Q_[N0], Q_[N1], . . . , Q_[Nm]) from a memory unit.

3. U transmits N and S_N to V via a network.

4. V executes Ver_[spk] ((N, Q_[N0], Q_[N1], . . . , Q_[Nm]), S_N), and if Ver outputs reject, V rejects the proof of U.

5. U proves to V the knowledge of x_U and R_[N0] which satisfies Q_[N0]=K_[O0]̂[x_U]L_[O0]̂[R_[N0]], and V verifies the proof.

U may prove the knowledge of x_U and R_[N0] using any kind of method. U, for example, can prove it using the method explained in the description of pseudonym generation (12 and 22).

<Attribute Proof 25 and Attribute Verification 35>

It is supposed that N is a pseudonym of U which is a user apparatus 2 in a group which an organization O manages.

U operates as follows when it proves i-th attribute of N, W_i, to V which is a verifier apparatus 3.

1. U reads K_[Oi], L_[Oi], W_i and R_[Ni] from a memory unit.

2. V reads K_[Oi], L_[Oi] and W_i from a memory unit.

3. U proves to V the knowledge of R_[Ni] which satisfies Q_[Ni]/K_[Oi]̂[H(W_i)]=L_[Oi]̂[R_[Ni]], and V verifies the proof.

U may prove the knowledge of R_[Ni] using any kind of method. U, for example, can prove it using the method explained in the description of pseudonym generation (12 and 22).

<Validation Tag Relationship Proof 26 and Validation Tag Relationship Verification 36>

It is supposed that O_{—}1 and O_{—}2 are organization apparatuses 1. O_{—}1 and O_{—}2 may also be the same organization.

It is supposed that (spk, K_[O_{—}10], L_[O_{—}10], . . . , K_[O_{—}1m], L_[O_{—}1m]) and (spk, K_[O_{—}20], L_[O_{—}20], . . . , K_[O_{—}2m], L_[O_{—}2m]) are a public key of O_{—}1 and O_{—}2 respectively.

It is also assumed that U which is a user apparatus 2 stores a pseudonym N_{—}1, a validation tag (Q_[N_{—}10], Q_[N_{—}11], . . . , Q_[N_{—}1m], W_[N_{—}11], . . . , W_[N_{—}1m], . . . , R_[N_{—}10], R_[N_{—}1m], S_M[N_{—}1]) corresponding to N_{—}1, a pseudonym N_{—}2 and a validation tag (Q_[N_{—}20], Q_[N_{—}21], . . . , Q_[N_{—}2m], W_[N_{—}21], . . . , W_[N_{—}2m], R_[N_{—}20], . . . , R_[N_{—}2m], S_[N_{—}2]) corresponding to N_{—}2, which are defined in a group managed by O_{—}1, in a memory unit.

U operates as follows when credential relationship proof is performed to V which is an independent verifier apparatus 3.

1. U reads K_[O_{—}10], L_[O_{—}10], x_U, (N_{—}1, Q_[N_{—}10], R_[N_{—}10], S_[N_{—}1]) and (N_{—}2, Q_[N_{—}20], R_[N_{—}20], S_[N_{—}2]) from a memory unit.

2. V reads spk, K_[O_{—}10], L_[O_{—}10], (N_{—}1, Q_[N_{—}10], Q_[N_{—}11], . . . , Q_[N_{—}1m]) and (N_{—}2, Q_[N_{—}20], Q_[N_{—}21], . . . , Q_[N_{—}2m]) from a memory unit.

3. U transmits S_[N_{—}1] and S_[N_{—}2] to V using a communication unit.

4. If at least one of Ver [spk] ((N_{—}1, Q_[N_{—}10], Q_[N_{—}11], . . . , Q_[N_{—}1m]), S_[N_{—}1]) and Ver_[spk] ((N_{—}12 Q_[N_{—}20], Q_[N_{—}21], . . . , Q_[N_{—}2m]), S_[N_{—}2]) is reject, V rejects the proof of U.

5. U proves to V the knowledge of (x_U, R_[N_{—}10], R_[N_{—}20]) which satisfies Q_[N_{—}10]=K_[O_{—}10]̂[x_U]L_[O_{—}10]̂[R_[N_{—}10]] and Q_[N_{—}20]=K_[O_{—}10]̂[x_U]L_[O_{—}20]̂[R_[N_{—}20]], and V verifies the proof.

U may prove the knowledge of (x_U, R_[N_{—}10], R_[N_{—}20]) using any kind of method. U, for example, can prove it using the following method.

1. V chooses elements c and r in Z_q at random and calculates C=K_[O0]̂cL_[O0]̂r.

2. U chooses elements x′, R′ 1 and R′ 2 in Z_q at random, calculates Q′_{—}1=K_[O_{—}10]̂[x′]L_[O_{—}10]̂[R′_{—}1] and Q′ 2=K_[O_{—}20]̂[x′]L_[O_{—}20]̂[R′_{—}2], and transmits Q′_{—}1 and Q′_{—}2 to V.

3. V transmits c and r to U.

4. U confirms whether C=K_[O0]̂cL_[O0]̂r is true. If C=K_[O0]̂cL_[O0]̂r is not true, U finishes the proof.

5. U calculates ρ_x=cx_U+x′, ρ_[R_{—}1]=cR_[N_{—}10]+R′_{—}1 and ρ_[R_{—}2]=cR_[N_{—}20]+R′_{—}2, and transmits ρ_x, ρ_[R_{—}1] and ρ_[R_{—}2] to V.

6. If Q_[N_{—}10]̂cQ′_{—}1=K_[O_{—}10]̂[ρ_x]L_[O_{—}10]̂[R′_{—}1] and Q_[N_{—}20]̂cQ′_{—}2=K_[O_{—}20]̂[ρ_x]L_[O_{—}20]̂[R′2] are true, V accepts the proof, otherwise, rejects the proof.

### The Second Exemplary Embodiment

In the second exemplary embodiment, pseudonym generation (12 and 22) is performed as follows. Other operations are the same as in the first exemplary embodiment.

<Pseudonym Generation (12 and 22)>

It is supposed that W_[N1], . . . , W_[Nm] are user's attributes.

U which is a user apparatus 2 and O which is an organization apparatus 1 perform pseudonym generation (12 and 22) using the following method.

1. O chooses a message N_{—}2 and sends it to U via a network.

2. U chooses a message N_{—}1 and defines a pseudonym N by N=N_{—}1∥N_{—}2.

3. U chooses elements R_[N0], R_[Nm] in G at random.

4. U calculates Q_[N0]=K_[O0]̂[x_U]L_[O0]̂[R_[N0]] and proves the validity of Q_[N0]. And O verifies the proof.

5. U calculates Q_[N1]=K_[O1]̂[H(W_{—}1)]L_[O1]̂[R_[N1]], . . . , Q_[Nm]=K_[Om]̂[H(W_m)]L_[Om]̂[R_[Nm]].

6. U sends (W_[N1], . . . , W_[Nm], R_[N0], . . . , R_[Nm], Q_[N0]) to O via a network.

7. O calculates Q_[N1]=K_[O1]̂[H(W_{—}1)]L_[O1]̂[R_[N1]], . . . , Q_[Nm]=K_[Om]̂[H(W_m)]L_[Om]̂[R_[Nm]].

8. U stores a pseudonym N, a validation tag (Q_[N0], Q_[N1], . . . , Q_[Nm]), W_[N1], . . . , W_[Nm], R_[N0], . . . , R_[Nm] in a memory unit.

U may prove the knowledge of x_U and R_[N0] using any kind of method. U, for example, can prove it using the method described in the first exemplary embodiment.

### The Third Exemplary Embodiment

In the first and second exemplary embodiments, U which is a user apparatus 2 chooses a new R_[Ni] whenever pseudonym generation (12 and 22) is performed.

However, depending on the purposes, the same R_[Ni] may be used by a plurality of pseudonym generation (12 and 22).

Also concerning the attributes, if W_[Ni] and R_[Ni] are the same during two times of pseudonym generations (12 and 22), Q_[N_{—}1i] created by the first pseudonym generation (12 and 22) and Q_[N_{—}2i] created by the second pseudonym generation (12 and 22) are identical. Therefore, in this case, validation tag relationship proof 26 and validation tag relationship verification 36 can be performed as follows.

<Validation Tag Relationship Proof 26 and Validation Tag Relationship Verification 36>

The steps 1. to 4. are the same respectively as those in validation tag relationship proof 26 and validation tag relationship verification 36 of the first exemplary embodiment.

The step 5. is performed as follows.

5. If Q_[N_{—}1i]=Q_[N_{—}2i] is true, V accepts the proof, otherwise, rejects the proof.

### The Fourth Exemplary Embodiment

It is supposed that E=(GenParam, SGen, VGen, Sig, Ver, DSig, Dyer) is a designated-verifier verification scheme.

Here, GenParam, SGen, VGen, Sig, Ver, DSig and Dyer are algorithms for public information generation, signer key generation, verifier key generation, original signature generation, verification and designated-verifier signature generation respectively. Further, it is supposed that G is a cyclic group having a prime order and a discrete logarithm problem on G is hard. Further, it is supposed that H is a hash function, and λ is a security parameter.

<Organization Key Generation 11>

O which is an organization apparatus 1 performs organization key generation 11 using the following method.

1. O reads λ from a memory unit.

2. O executes GenParam(λ) and gets output of GenParam param. Further, O executes SGen, and gets a public key spk and a secret key ssk.

3. O chooses a natural number m and chooses elements K_[O0], L_[O0], . . . , K_[Om], L_[Om] in G at random.

4. (param, spk, K_[O0], L_[O0], K_[Om], L_[Om]) is considered as a public key and ssk is considered as a secret key.

5. O writes a public key (param, spk, K_[O0], L_[O0], K_[Om], L_[Om]) and a secret key ssk in a memory unit.

6. O publishes a public key (param, spk, K_[O0], L_[O0], K_[Om], L_[Om]).

<User Secret Key Generation 21>

U which is a user apparatus 2 performs pseudonym generation (12 and 22) using the same method as in the first exemplary embodiment.

That is, U performs user secret key generation 21 using the following method.

1. U chooses an element x_U in G at random.

2. U writes x_U in a memory unit.

<Pseudonym Generation (12 and 22)>

It is supposed that W_[N1], . . . , W_[Nm] are user's attributes.

U which is a user apparatus 2 and an organization O perform pseudonym generation (12 and 22) using the same method as in the first exemplary embodiment.

<Credential Generation (13 and 23)>

U which is a user apparatus 2 and an organization O perform credential generation (13 and 23) using the following method.

1. U reads (N, Q_[N0], Q_[N1], . . . , Q_[Nm]) from a memory unit and sends (N, Q_[N0], Q_[N1], . . . , Q_[Nm]) to O via a network.

2. O reads param and ssk from a memory unit, calculates an original signature S_N=Sig_[param, ssk](N, Q_[N0], Q_[N1], . . . , Q_[Nm]) corresponding to (N, Q_[N0], Q_[N1], . . . , Q_[Nm]) and transmits S_N to U.

3. U reads param and spk from a memory unit, executes Ver_[param, spk] ((N, Q_[N0], Q_[N1], . . . , Q_[Nm]), S_N), and if Ver_[param, spk] outputs accept, writes S_N as a credential in a memory unit. Otherwise, credential generation (13 and 23) fails.

<Credential Possession Proof 24 and Credential Possession Verification 34>

It is supposed that N is a pseudonym of U which is a user apparatus 2 in a group which an organization O manages.

U operates as follows when U proves to V which is a verifier apparatus 3 possession of a credential corresponding to N.

1. U reads public information param, a public key of an organization O, K_[O0], L_[O0] and (N, Q_[N0], x_U, R_[N0], S_N) from a memory unit.

2. V reads a public key spk of an organization O, K_[O0], L_[O0] and (N, Q_[N0], Q_[N1], . . . , Q_[Nm]) from a memory unit.

3. V executes VGen(λ), gets a public key vpk and vsk as an output of VGen, transmits vpk to U and proves to U the validity of vpk. V verifies the proof.

4. U executes DSig_[param, spk, vpk](N, S_N), gets output of DSig σ_N, and transmits N and σ_N to V via a network.

5. V executes DVer_[param, spk, vpk] ((N, Q_[N0], Q_[N1], . . . , Q_[Nm]), σ_N), and if DVer outputs reject, V rejects the proof of U.

6. U proves to V the knowledge of x_U and R_[N0] which satisfies Q_[N0]=K_[O0]̂[x_U]L_[O0]̂[R_[N0]]. V verifies the proof.

U may prove the knowledge of x_U and R_[N0] using any kind of method. U, for example, can prove it using the method described in pseudonym generation (12 and 22) of the first exemplary embodiment.

<Attribute Proof 25 and Attribute Verification 35>

It is supposed that N is a pseudonym of U which is a user apparatus 2 in a group which an organization O manages.

U operates similar to the first exemplary embodiment when U proves i-th attribute of N, W_i, to V which is a verifier apparatus 3.

<Validation Tag Relationship Proof 26 and Validation Tag Relationship Verification 36>

It is supposed that O_{—}1 and O_{—}2 are organization apparatuses 1. O_{—}1 and O_{—}2 may also be the same organization.

It is supposed that (spk, K_[O_{—}10], L_[O_{—}10], . . . , K_[O_{—}1m], L_[O_{—}1m]) and (spk, K_[O_{—}20], L_[O_{—}20], . . . , K_[O_{—}2m], L_[O_{—}2m]) are a public key of O_{—}1 and O_{—}2 respectively.

Further it is assumed that U which is a user apparatus 2 stores a pseudonym N_{—}1, a validation tag (Q_[N_{—}10], Q_[N_{—}11], . . . , Q_[N_{—}1m], W_[N_{—}11], . . . , W_[N_{—}1m], R_[N_{—}10], . . . , R_[N_{—}1m], σ[N_{—}1]) corresponding to N_{—}1, a pseudonym N_{—}2 and a validation tag (Q_[N_{—}20], Q_[N_{—}21], . . . , Q_[N_{—}2m], W_[N_{—}21], . . . , W_[N_{—}2m], R_[N_{—}20], . . . , R_[N_{—}2m], σ[N_{—}2]) corresponding to N_{—}2, which are defined in a group managed by O_{—}1, in a memory unit.

U operates as follows when U performs credential relationship proof to V which is a verifier apparatus 3.

1. U reads K_[O_{—}10], L_[O_{—}10], x_U, (N_{—}1, Q_[N_{—}10], R_[N_{—}10], σ[N_{—}1]) and (N_{—}2, Q_[N_{—}20], R_[N_{—}20], σ[N_{—}2]) from a memory unit.

2. V reads param, spk, K_[O_{—}10], L_[O_{—}10], (N_{—}1, Q_[N_{—}10], Q_[N_{—}11], . . . , Q_[N_{—}1m]) and (N_{—}2, Q_[N_{—}20], Q_[N_{—}21], . . . , Q_[N_{—}2m]) from a memory unit.

3. U transmits σ[N_{—}1] and σ[N_{—}2] to V using a communication unit.

4. If at least one of Ver_[param, spk] ((N_{—}1, Q_[N_{—}10], Q_[N_{—}11], . . . , Q_[N_{—}1m]), σ[N_{—}1]) and Ver_[param, spk] ((N_{—}12 Q_[N_{—}20], Q_[N_{—}21], . . . , Q_[N_{—}2m]), σ[N_{—}2]) is reject, V rejects the proof of U.

5. U proves to V the knowledge of (x_U, R_[N_{—}10], R_[N_{—}20]) which satisfies Q_[N_{—}10]=K_[O_{—}10]̂[x_U]L_[O_{—}10]̂[R_[N_{—}10]] and Q_[N_{—}20]=K_[O_{—}10]̂[x_U]L_[O_{—}20]̂[R_[N_{—}20]]. V verifies the proof.

U may prove the knowledge of (x_U, R_[N_{—}10], R_[N_{—}20]) using any kind of method. U, for example, can prove it using the method described in the first exemplary embodiment.

### The Fifth Exemplary Embodiment

In the fifth exemplary embodiment, pseudonym generation (12 and 22) is performed using the same method as in the second exemplary embodiment. Other operations are the same as in the fourth exemplary embodiment.

### The Sixth Exemplary Embodiment

In the sixth exemplary embodiment, pseudonym generation (12 and 22) is performed using the same method as in the third exemplary embodiment. Other operations are the same as in the fourth exemplary embodiment.

### The Seventh Exemplary Embodiment

In the fourth exemplary embodiment, though V is generating vpk and vsk whenever credential possession proof (24 and 34) is performed, V may use the same vpk and vsk in all credential possession proof (24 and 34) depending on the use.

### Example 1

In example 1, a case which uses a method of non-patent literature 2 as a designated-verifier verification scheme Σ=(GenParam, SGen, VGen, Sig, Ver, DSig, Dyer) of the second exemplary embodiment is described.

It is supposed that groups G_{—}1, G_{—}2 and G_T have an order of λ bit, and have a pairing <*,*>: G_{—}1×G_{—}2->G_T and a mapping ψ: G_{—}2->G_{—}1.

It is supposed that q is an order of G_{—}1 (=order of G_{—}2=order of G_T). It is supposed that H is a hash function which has a range over G_{—}2. It is supposed that G=G_{—}1.

<Organization Key Generation 11>

O which is an organization apparatus 1 performs organization key generation 11 using the following method.

1. O reads λ from a memory unit.

2. O chooses an element g_{—}1 in G_{—}1 at random, executes g_{—}2=ψ(g_{—}1), lets param=(g_{—}1, g_{—}2), chooses an element ssk in Z_q at random and calculates spk=g_{—}1̂[ssk].

3. O chooses a natural number m and chooses elements K_[O0], L_[O0], . . . , K_[Om] and L_[Om] in G at random.
4. (param, spk, K_[O0], L_[O0], K_[Om], L_[Om]) is considered as a public key and ssk is considered as a secret key.

5. O writes a public key (param, spk, K_[O0], L_[O0], . . . , K_[Om], L_[Om]) and a secret key ssk in a memory unit.

6. O publishes a public key (param, spk, K_[O0], L_[O0], . . . , K_[Om], L_[Om]).

<User Secret Key Generation 21>

U which is a user apparatus 2 performs pseudonym generation (12 and 22) using the same method as in the first exemplary embodiment.

That is, U performs user secret key generation 21 using the following method.

1. U chooses an element x_U in G_{—}1 at random.

2. U writes x_U in a memory unit.

<Pseudonym Generation (12 and 22)>

It is supposed that W_[N1], . . . , W_[Nm] are user's attributes.

U which is a user apparatus 2 and O which is an organization apparatus 1 perform pseudonym generation (12 and 22) using the same method as in the first exemplary embodiment.

<Credential Generation (13 and 23)>

U which is a user apparatus 2 and O which is an organization apparatus 1 perform credential generation (13 and 23) using the following method.

1. U reads (N, Q_[N0], Q_[N1], . . . , Q_[Nm]) from a memory unit and sends (N, Q_[N0], Q_[N1], . . . , Q_[Nm]) to O via a network.

2. O reads param and ssk from a memory unit, calculates an original signature S_N=H(N, Q_[N0], N, Q_[N1], . . . , Q_[Nm])̂[ssk] corresponding to (N, Q_[N0], Q_[N1], . . . , Q_[Nm]) and transmits S_N to U.

3. U reads param and spk from a memory unit, and if <g_{—}1, S_N>=<spk, H((N, Q_[N0], Q_[N1], . . . , Q_[Nm]), S_N)>, then writes S_N as a credential in a memory unit. Otherwise, credential generation (13 and 23) fails.

<Credential Possession Proof 24 and Credential Possession Verification 34>

It is supposed that N is a pseudonym of U which is a user apparatus 2 in a group which an organization O manages.

U operates as follows when U proves to V which is a verifier apparatus 3 possession of a credential corresponding to N.

1. U reads public information param, a public key of an organization O, K_[O0], L_[O0] and (N, Q_[N0], x_U, R_[N0], S_N) from a memory unit.

2. V reads a public key spk of an organization O, K_[O0], L_[O0] and (N, Q_[N0], Q_[N1], . . . , Q_[Nm]) from a memory unit.

3. V chooses an element vsk in Z_q at random, lets vpk=g_{—}1̂[vsk], transmits vpk to U and proves to U the validity of vpk. V verifies the proof.

4. Let σ_N=<vpk, S_N>, and transmit N and σ_N to V via a network.

5. If σ_N=<spk̂[vsk], H(N, Q_[N1], . . . , Q_[Nm])> is not true, V rejects the proof of U.

6. U proves to V the knowledge of x_U and R_[N0] which satisfies Q_[N0]=K_[O0]̂[x_U]L_[O0]̂[R_[N0]]. V verifies the proof.

U may prove the knowledge of x_U and R_[N0] using any kind of method. U, for example, can prove it using the method described in pseudonym generation (12 and 22) of the first exemplary embodiment.

<Attribute Proof 25 and Attribute Verification 35>

It is supposed that N is a pseudonym of U which is a user apparatus 2 in a group which an organization O manages.

U operates similar to the first exemplary embodiment when it proves i-th attribute of N, W_i, to V which is a verifier apparatus 3.

<Validation Tag Relationship Proof 26 and Validation Tag Relationship Verification 36>

It is supposed that O_{—}1 and O_{—}2 are organization apparatuses 1. O_{—}1 and O_{—}2 may also be the same organization.

It is supposed that (spk, K_[O_{—}10], L_[O_{—}10], . . . , K_[O_{—}1m], L_[O_{—}1m]) and (spk, K_[O_{—}20], L_[O_{—}20], . . . , K_[O_{—}2m], L_[O_{—}2m]) are a public key of O_{—}1 and O_{—}2 respectively.

Further it is assumed that U which is a user apparatus 2 stores a pseudonym N_{—}1, a validation tag (Q_[N_{—}10], Q_[N_{—}11], . . . , Q_[N_{—}1m], W_[N_{—}11], . . . , W_[N_{—}1m], R_[N_{—}10], . . . , R_[N_{—}1m], σ_[N_{—}1]) corresponding to N_{—}1, a pseudonym N_{—}2 and a validation tag (Q_[N_{—}20], Q_[N_{—}21], . . . , Q_[N_{—}2m], W_[N_{—}21], . . . , W_[N_{—}2m], R_[N_{—}20], R_[N_{—}2m], σ_[N_{—}2]) corresponding to N_{—}2, which are defined in a group managed by O_{—}1, in a memory unit.

U operates as follows when credential relationship proof is performed to V which is a verifier apparatus 3.

1. U reads K_[O_{—}10], L_[O_{—}10], x_U, (N_{—}1, Q_[N_{—}10], R_[N_{—}10], σ[N_{—}1]) and (N_{—}2, Q_[N_{—}20], R_[N_{—}20], σ[N_{—}2]) from a memory unit.

2. V reads param, spk, K_[O_{—}10], L_[O_{—}10], (N_{—}1, Q_[N_{—}10], Q_[N_{—}11], . . . , Q_[N_{—}1m]) and (N_{—}2, Q_[N_{—}20], Q_[N_{—}21], . . . , Q_[N_{—}2m]) from a memory unit.

3. U transmits σ_[N_{—}1] and σ_[N_{—}2] to V using a communication unit.

4. If at least one of σ_[N_{—}1]=<spk̂[vsk], H((N_{—}1, Q_[N_{—}10], Q_[N_{—}11], . . . , Q_[N_{—}1m]))>, and σ_[N_{—}2]=<spk̂[vsk], H((N_{—}2, Q_[N_{—}20], Q_[N_{—}21], . . . , Q_[N_{—}2m]))> is not true, V rejects the proof of U.

5. U proves to V the knowledge of (x_U, R_[N_{—}10], R_[N_{—}20]) which satisfies Q_[N_{—}10]=K_[O_{—}10]̂[x_U]L_[O_{—}10]̂[R_[N_{—}10]] and Q_[N_{—}20]=K_[O_{—}10]̂[x_U]L_[O_{—}20]̂[R_[N_{—}20]]. V verifies the proof.

U may prove the knowledge of (x_U, R_[N_{—}10], R_[N_{—}20]) using any kind of method. U, for example, can prove it using the method described in the first exemplary embodiment.

### Example 2

The present invention can be applied to an electronic certificate. In these applications, a special organization called CA exists, and CA bears the role of checking the identity of each user.

In order for a user to use an anonymous credential system, first, the user accesses CA. After checking the user's identity, CA performs together with the user pseudonym generation 12 and credential generation 13, and issues a pseudonym, a validation tag and a credential to the user.

In application to a certificate, a license issuing center acts as an organization.

When acquiring a license, a user, without disclosing a real name, shows instead a pseudonym which CA issued.

Further the user performs credential possession proof 24 to the license issuing center.

The user gets the permission from the license issuing center to acquire a license.

When the license issuing center gives to the user permission to acquire a license, the license issuing center issues a new pseudonym P, a validation tag T and a credential pf by performing together with the user pseudonym generation 12 and credential generation 13.

A credential corresponds to a certificate, and proves that the user whose pseudonym is P has a license.

Whenever the user is requested for presentation of a certificate, the user performs credential possession proof 24.

The present invention can also be applied to a membership card in the same way.

In the application to a membership card, an organizer of a members club acts as an organization.

In this application, a credential corresponds to a membership Card, not to a certificate.

Therefore, whenever a user use a club, the user can prove that he/she is a member of a club by performing credential possession proof 24. Other details are similar to the case of a certificate.

A user can prove his attribute by performing attribute proof 25 as needed. For example, when a use uses service which is available only to a person no less than 20-year-old, the user can use this service by proving the attribute which is the age.

A user has a plurality of certificates and membership cards under a plurality of pseudonyms. A user can prove that those certificates and membership cards actually belong to the identical person by performing validation tag relationship proof 26.

Further, each exemplary embodiment mentioned above is the preferred embodiment of the present invention, and various changes of implementation are possible within the scope that does not deviate from the point of the present invention. For example, by supplying storage media, which store a program code of software that realizes the function of each apparatus among the first to the seventh exemplary embodiment, to a system or an apparatus, the system or a computer of the apparatus may read the program code which is stored in the storage media and execute it. Or the program may be transmitted to other computer systems via a CD-ROM or a magneto-optical disk which are the computer-readable recording media, or via transmission media like an internet or a telephone line over a transmission wave.

Further, this application claims priority based on Japanese patent application number 2007-301466 which is filed on Nov. 21, 2007 and the disclosure thereof is incorporated herein in its entirety.

### INDUSTRIAL APPLICABILITY

For example, the present invention is applicable to an information and communication system including a user apparatus, an organization apparatus and a verifier apparatus.

### BRIEF DESCRIPTION OF THE DRAWINGS

FIG. 1 is a block diagram of non-patent literature 1.

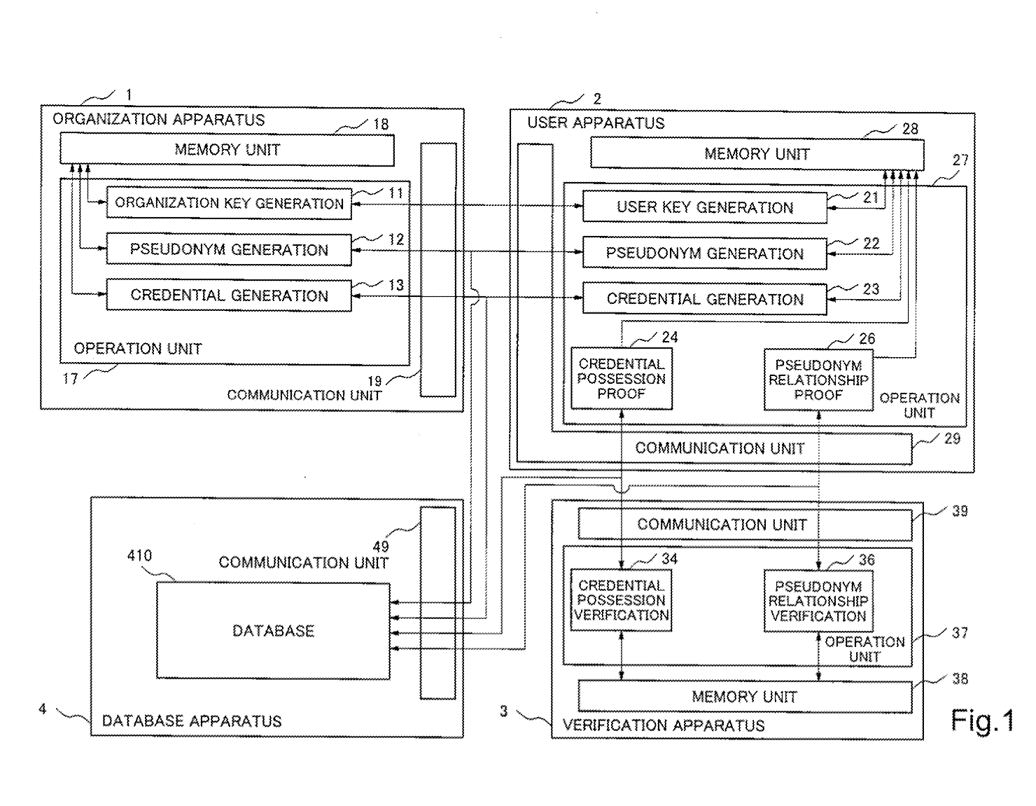

FIG. 2 is a block diagram according to the exemplary embodiment of the present invention.

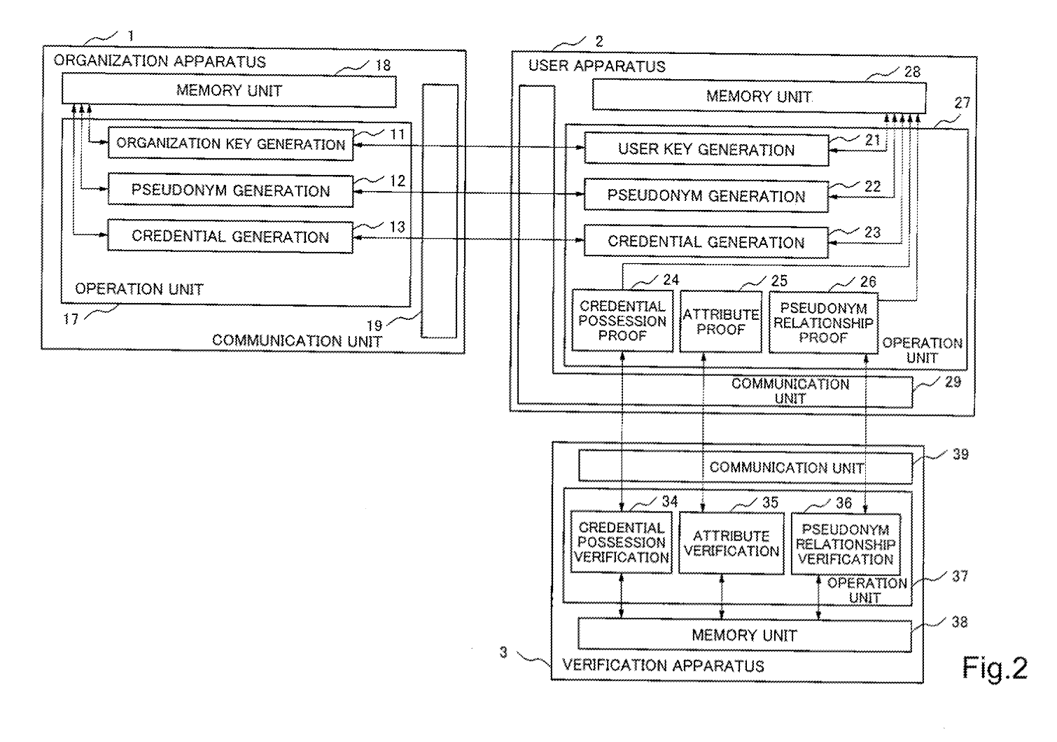

### DESCRIPTION OF CODE

1 Organization apparatus
2 User apparatus
3 Verifier apparatus
17, 27 and 37 Operation unit
18, 28 and 38 Memory unit
19, 29 and 39 Communication unit

1-19. (canceled)

20. An information and communication system comprising:
an organization apparatus, a user apparatus and a verifier apparatus, wherein
said user apparatus includes its own secret key;
and said organization apparatus and said user apparatus further include:
a pseudonym generation unit that generates a validation tag including a commitment of a secret key of said user apparatus and a pseudonym; and
a certificate generation unit that generates a signed document corresponding to said validation tag and said pseudonym as a credential which is a information which proves that a pseudonym and a validation tag are issued by said organization apparatus;
wherein
said user apparatus includes
a proof unit which proves possession of a credential; and
said verifier apparatus includes
a verification unit which verifies possession of a credential, wherein
said proof unit transmits said signed document to said verifier apparatus, and proves to said verifier apparatus that said validation tag is a commitment of said secret key; and
said verification unit verifies said signed document, and further verifies a proof that said validation tag is a commitment of said secret key.

21. An information and communication system according to claim 20, wherein
said user apparatus includes a validation tag relationship proof unit which, when each of no less than two organization apparatuses issues one or a plurality of pseudonyms and validation tags, proves to said verifier apparatus that said one or a plurality of validation tags are generated using the same secret key; and
said verifier apparatus includes a validation tag relationship verification unit which verifies a proof that said one or a plurality of validation tags are generated using the same secret key.

22. An information and communication system according to claim 20, wherein
said user apparatus proves to said organization apparatus that said validation tag includes a commitment of a secret key; and
said organization apparatus verifies a proof that said validation tag includes a commitment of a secret key.

23. An information and communication system according to claim 20, wherein
a commitment C of said secret key x is created by C=K̂xL̂R based on public information K, L and R chosen at random.

24. An information and communication system according to claim 20, wherein
said pseudonym generation unit creates a commitment of an attribute corresponding to a pseudonym;
said validation tag includes a commitment of said secret key and a commitment of said attribute;
said user apparatus includes an attribute proof unit which proves to said verifier apparatus that said validation tag is a commitment of an attribute; and
said verifier apparatus includes an attribute verification unit which verifies a proof that said validation tag is a commitment of an attribute.

25. An information and communication system according to claim 24, wherein
said attribute proof unit proves to said organization apparatus that said validation tag includes a commitment of a secret key and a commitment of an attribute; and
said attribute verification unit verifies a proof that said validation tag includes a commitment of a secret key and a commitment of an attribute.

26. An information and communication system according to claim 24, wherein
a commitment C of said secret key x is created by C=K̂xL̂R based on public information K, L and R chosen at random; and
a commitment C_i of W_i, i-th element of said attribute, is created by C=K̂[W_i]L̂[R_i] based on public information K_i, L_i and R_i chosen at random.

27. An organization apparatus of an information and communication system according to claim 20.

28. A user apparatus of an information and communication system according to claim 20.

29. An information and communication system comprising:
an organization apparatus, a user apparatus and a verifier apparatus, wherein
said user apparatus includes its own secret key;
and said organization apparatus and said user apparatus;
a pseudonym generation unit which generates a validation tag including a commitment of a secret key of said user apparatus and a pseudonym; and
a certificate generation unit that generates a signed document corresponding to said validation tag and said pseudonym as a credential which is an information which proves that a pseudonym is issued by said organization apparatus;
wherein
said user apparatus includes
a proof unit which proves possession of a credential; and
said verifier apparatus includes
a verification unit which verifies possession of a credential, wherein
said pseudonym generation unit generates a pseudonym based on a predetermined bit string;
said certificate generation unit creates an original signed document corresponding to said validation tag according to an original signature generation method of an universal designated-verifier signature scheme and
outputs said original signed document as a credential;
said proof unit proves a knowledge of said original signed document not being based on said original signed document; and
said verification unit verifies a knowledge of said original signed document not being based on said original signed document.

30. An information and communication system according to claim 29, wherein
said proof unit generates a designated-verifier signature from said original signed document according to a designated-verifier signature generation method of said universal designated-verifier signature scheme; and transmits said designated-verifier signatures to a verifier apparatus;
said proof unit proves to a verifier apparatus that said validation tag is a commitment of a secret key; and
said verification unit verifies said designated-verifier signed document, and verifies a proof that said validation tag is a commitment of a secret key.

31. An information and communication system according to claim 29, wherein
said user apparatus includes a validation tag relationship proof unit which, when each of no less than two organization apparatuses issues one or a plurality of pseudonyms and validation tags, proves to a verifier apparatus that said one or a plurality of validation tags are generated using the same secret key; and
said verifier apparatus includes a validation tag relationship verification unit which verifies a proof that one or a plurality of validation tags are generated using the same secret key.

32. An information and communication system according to claim 29, wherein
said user apparatus proves to said organization apparatus that said validation tag includes a commitment of a secret key; and
said organization apparatus verifies a proof that said validation tag includes a commitment of a secret key.

33. An information and communication system according to claim 29, wherein
said commitment C of said secret key x is created by C=K̂xL̂R based on public information K, L and R chosen at random.

34. An information and communication system according to claim 29, wherein
said pseudonym generation unit creates a commitment of an attribute corresponding to a pseudonym;
said validation tag includes a commitment of said secret key and a commitment of said attribute;
said user apparatus includes an attribute proof unit which proves to said verifier apparatus that a commitment included in a validation tag corresponding to said attribute includes a commitment of an attribute; and
said verifier apparatus includes an attribute verification unit which verifies a proof that a commitment included in a validation tag corresponding to said attribute includes a commitment of an attribute.

35. An information and communication system according to claim 34, wherein
said attribute proof unit proves to said organization apparatus that said validation tag includes a commitment of a secret key and a commitment of an attribute; and
said attribute verification unit verifies a proof that said validation tag includes a commitment of a secret key and a commitment of an attribute.

36. An information and communication system according to claim 34, wherein
a commitment C_i of W_i, i-th element of said attribute, is created by C=K̂[W_i]L̂[R_i] based on public information K_i, L_i and R_i chosen at random; and
said commitment C of said secret key x is created by C=K̂xL̂R based on public information K, L and R chosen at random.

37. An organization apparatus of an information and communication system according to claim 29.

38. A user apparatus of an information and communication system according to claim 29.
